(19) United States
(12) Patent Application Publication
(10) Pub. No.: US 2011/0232584 A1
(43) Pub. Date: Sep. 29, 2011

(54) Animal Control Devices, Systems And Methods of Using Animal Control Devices

(76) Inventor: Jeff Valencia, Solana Beach, CA (US)

(21) Appl. No.: 12/892,906

(22) Filed: Sep. 28, 2010

Related U.S. Application Data
(60) Provisional application No. 61/246,499, filed on Sep. 28, 2009.
(60) Provisional application No. 61/382,905, filed on Sep. 14, 2010.

(51) Int. Cl. A01K 15/02

(52) U.S. Cl. 119/719

(57) ABSTRACT

Embodiments of the claimed subject matter relate to devices, systems and methods using those devices used in training animals, and more particularly, devices that can be attached or used in conjunction with collars and/or leashes with provide one or more alerts for eliciting and enhancing the responsiveness of the animal. One example device for training animals includes a housing with a connector for a leash, a noise emitter capable of producing one or more noises with one or more ranges of frequencies, a circuit that signals the audio device to provide or stop the one or more noises and a switch to activate the circuit. The circuit is activated when the leash is pulled with a predetermined amount of force and the circuit activates the noise emitter which produces one or more noises. The circuit is deactivated when the leash is released and the noise emitter stops emitting noise.

### CROSS-REFERENCES TO RELATED PATENT APPLICATIONS

The subject matter described in the present application is related to that described in the U.S. Patent Application No. 61/246,499 to Valencia filed Sep. 28, 2009 and U.S. Patent Application No. 61/382,905 to Valencia filed Sep. 14, 2010, now pending, each of which is incorporated by reference herein in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD

Embodiments of the claimed subject matter relate to devices, systems and methods using those devices used in training animals, and more particularly, devices that can be attached or used in conjunction with collars providing one or more alerts for eliciting and enhancing the responsiveness of the animal.

### BACKGROUND

It is well know that many devices have been disclosed in the prior art that assist in training and enhance the responsiveness of animals. Of particular interest are training devices which are worn by animals.

For example, U.S. Pat. No. 6,748,902 (issued to Boesch et al.) discloses an animal worn training device that attaches to a lead having a transducer that responds to the amount of force pulling on the leash. If the force from pulling exceeds a first threshold a warning audio tone sounds and if the force from pulling strength exceeds a second threshold level, then a shock is administered to the animal.

United States Published Application No. 2007/0261645 to Van De Merwe et al. discloses a pet leash apparatus that deters a dog from pulling on the leash. The focus of this disclosure is towards spray to control the animal. Ultrasound emissions and electrical shocks are also disclosed though the main focus remains on spraying the animal.

U.S. Pat. No. 6,116,192 to Hultine et al. describes an animal training device which is a electric pulse generator attached between the collar and leash that is used to shock as animal. The disclosed device has cylindrical, sliding inner and outer housings.

Patent Number DE 20313319 to Flexi Bogdahn Tech relates to an animal control device with a cable 30 wound on a reel, a battery and a sensor used to activate a loudspeaker via a metal clamp near the end of the lead. As the metal clamp approaches the sensor, a signal is emitted that can be recognized by the animal.

United States Published Patent Application No. 2008/0173257 to Steiner et al. describes a retractable animal leash and methods for animal control. The apparatus can be configured to generate unpleasant high-sonic or ultrasonic (e.g., greater than 20 kHz) emissions akin to a dog whistle.

To the best of the inventors' knowledge, the present embodiments of such improved devices and methods have not been provided in the art. The present application provides some of such improved methods and devices that are useful in the training of animals.

### SUMMARY

According to one aspect of the invention, there is provided an activation device for an ultrasonic transducer which is capable of producing sound waves having one or more predetermined or user adjustable decibel level and one or more predetermined or user adjustable frequencies. The activation device is coupled to a circuit that is used to produce sound waves. A battery supply can provide electrical power for circuits and the transducer.

Embodiments described herein detail devices and methods that are useful in the training of animals, specifically dogs. These embodiments employ devices that provide an alert for an animal to enhance the responsiveness of the animal. In one embodiment, sound waves having a sufficiently high frequency to be inaudible to humans but audible to many animals, such as dogs, are employed to provide an alert.

In another embodiment, the sound level produced, as measured in decibels, can be altered for different training purposes. For example, one sound wave may be produced to elicit one desired behavior or two or more different sound waves can be used to elicit desired behaviors in the animal.

In another embodiment, a circuit board is configured with a circuit can be used to regulate the production of sound. The circuit board has inputs to receive signals from an activation mechanism. The activation mechanism produces signals upon the occurrence of an event, for example, movement in a mechanical device, which can be used to trigger the activation mechanism. The switches, or other activation device, can be configured to produce different volumes of sound.

In another embodiment an indicator light activates if the device is producing sound waves to enable humans to understand the events as they occur. In another embodiment, two casing layers are used to house the unit and movements of the two casing relative to each other causes the sounds waves to be produced.

### BRIEF DESCRIPTION OF THE DRAWINGS

FIG. 1 is an illustration of an embodiment of an activation device;

FIG. 2 is an illustration of the embodiment of FIG. 1 showing motion activation;

FIG. 3 is an illustration of the embodiment of FIG. 1 showing the inner casing;

FIG. 4 is an illustration of the embodiment of FIG. 1 showing the outer casing;

FIG. 5 is an illustration of an embodiment for electronics that can be used with the activation device shown of FIG. 1; and

FIG. 6 is an embodiment of a circuit diagram for controlling an ultrasonic transducer.

FIG. 7 is an illustration of another embodiment of the inventive subject matter;

FIG. 8 is an illustration of the embodiment of FIG. 7 with a clip attachment positioned at the rear of the embodiment;

FIG. 9 is an illustration of the embodiment of FIG. 7 shown from the top with a clip attachment positioned at the rear of the embodiment;

FIGS. 10A and 10B are illustrations of several components an embodiment of FIG. 7 with a clip attachment positioned at the rear of the embodiment;

FIG. 11 is an illustration of the embodiment of FIG. 7 showing the use with an external 9 Volt battery supply;

FIG. 12 shows a breakaway view of a PCB with side walls according to an embodiment of the subject matter;

FIG. 13 shows a breakaway view of a PCB without side walls according to an embodiment of the subject matter;

FIG. 14 shows additional housing configurations used with embodiment of the subject matter;

FIG. 15 shows a breakaway view of a PCB without side walls according to an embodiment of the subject matter;

FIG. 16 is an illustration of several components of an embodiment including a channel for a slideable line, cord or rope which may be used with embodiments of the subject matter; and

FIG. 17 shows a housing configuration used with an embodiment of the subject matter.

### DETAILED DESCRIPTION

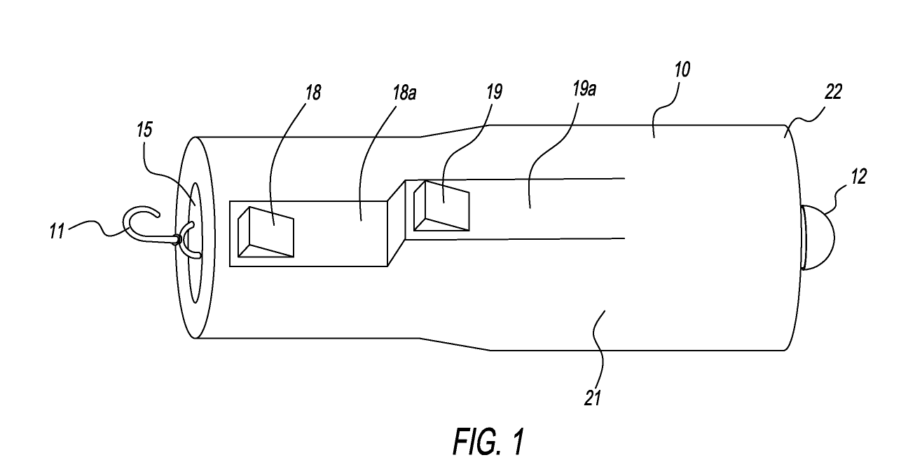

Referring first to FIG. 1, an illustration for an embodiment of an activation device 10 is shown which is constructed using an outer casing 21 and an inner casing 22 that are slideably engaged with each other such that inner casing 22 can slide in to and out of, of outer casing 22. Activation device 10 has first attachment mechanism 11 for attachment to an animal collar and second attachment mechanism 12 used for attachment to a leash for a dog or other type of animal. Audio device 15 provides an alert once collar 10 is stretched beyond a certain point. The outer casing 21 to activation device 10 has cut out area 18a and protrusion area 19a that allow for accommodation of levers 18, 19. Levers 18, 19 are contained on inner casing 22 and used to activate the alert generated by audio device 15. Inner casing 22 is slideably mounted with respect to outer casing 21.

A pulling force exerted on activation device 10 while attached to an animal will force outer casing 21 to slide with respect to inner casing 22 effectively elongating collar 10. As the outer casing 21 slides over outer casing 22, protrusion area 19a no longer abuts lever 19. Instead an area of outer casing 21 without any cut out or protrusion areas abuts lever 19 causing a depression of lever 19. The depression of lever 19 causes an ultrasonic alert sound to be made by audible device 15. The activation device 10 can be used for training of animals, including dogs, horses. Activation device can provide an alert useful in training an animal and enhance the responsiveness of the animal.

It should be understood that levers 18, 19 are just one possible mechanism that can be used within the embodiment shown in FIG. 1 to activate the alert. Other mechanisms can be used in varying embodiment that can detect to the mechanical movements are also envisioned. Optical detectors could be used in place of levers 18, 19. In FIG. 1, lever 19 is shown as a dotted line because it is contained below outer casing 21. Lever 18 is shown as solid lines because area 18a is actually a cut out in outer casing 21. It should be understood that cut out area 18a and protrusion area 19a are simply examples contained in a single embodiment and that numerous variations are envisioned.

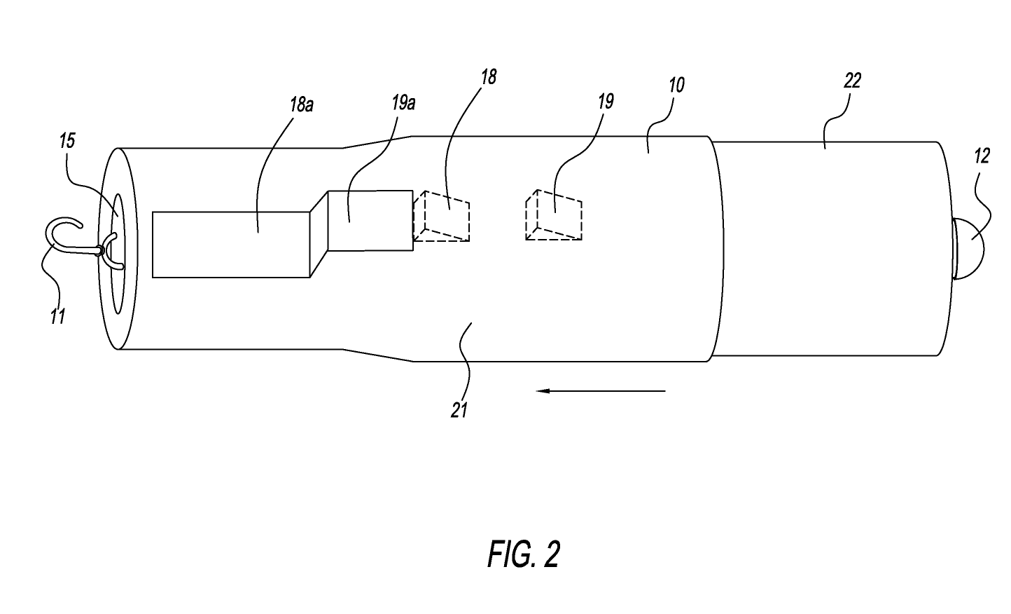

Referring to FIG. 2, which is an illustration of the activation device 10 sliding as a result of pulling by an animal on a leash connected to attachment mechanism 12 causing the outer casing 21 to slide with respect to inner casing 22. It should be noted that first attachment mechanism 11 and second attachment mechanism 12 would normally be attached to each other during use and that a dog leash (not shown) would attach to one of the either the first attachment mechanism 11 or second attachment mechanism 12. In FIG. 2, the protrusion 19a in the outer casing 21 has slid past both levers 18 and 19. As a result, both levers 18 and 19 are beneath outer casing 21 are shown in dotted lines. The sliding of outer casing 21 over lever 19 causes a first audible alert to be sounded by audio device 15. Once outer casing 21 slides over lever 18, a second audible alert is sounded.

Various embodiments are envisioned here. For example, the first and second audible alerts can be the same frequency and decibel level; different frequencies having the same or similar decibel levels; or the same frequencies with different decibels levels. Additional embodiments are envisioned that will have continuous alerts sounding, alerts that are a series of beeps or simply a single sound made be the depression of each of levers 18 and 19.

An embodiment will have audible device 15 create sound waves that have a sufficiently high frequency to be inaudible to humans but audible to many animals, such as dogs, are employed to provide an alert. In another embodiment, the sound level produced, or decibels, can be altered for different training purposes. The sound waves can be triggered to mandate desired behaviors in the animal.

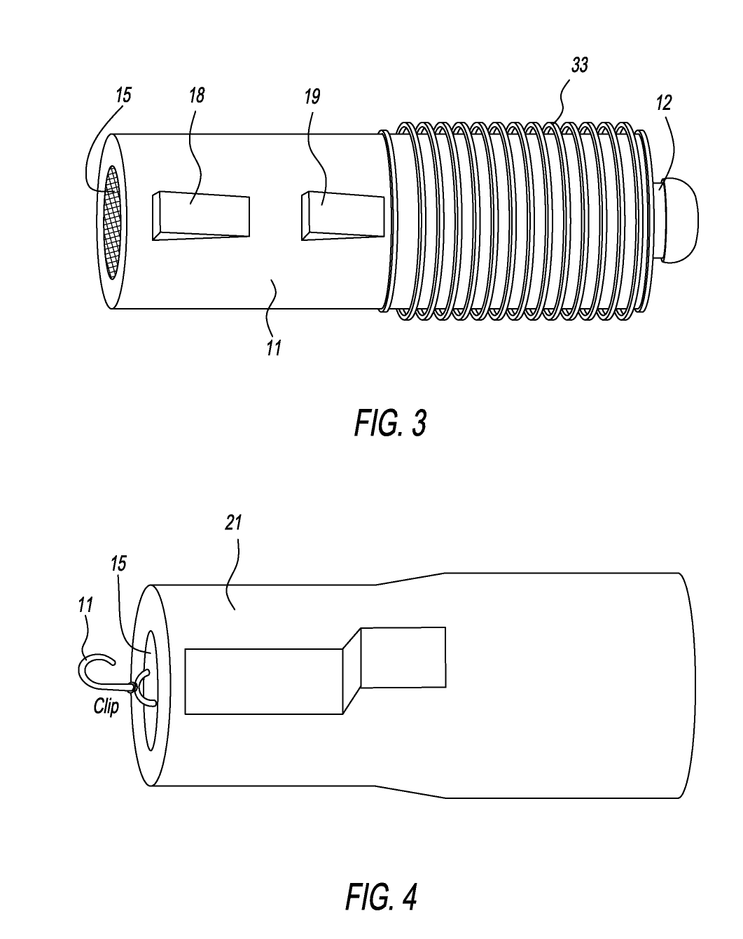

FIG. 3 shows the outside of the inner casing 22 with the outer casing 21 removed. Levers 18, 19 as well as audio device 15, attachment mechanism 12 and spring 33 are connected to inner casing 22. Spring 33 provides a biasing force that keeps activation device 10 in the original state shown in FIG. 1. The biasing can alternatively be provided by elastomeric materials or any type of device that will provide a biasing force. FIG. 4 shows the outer casing 21 with a clip for attaching to a collar as attachment device 11. Aperture 25 is formed in outer casing 21 to allow audio device 15 to have access to the ambient surroundings to be heard.

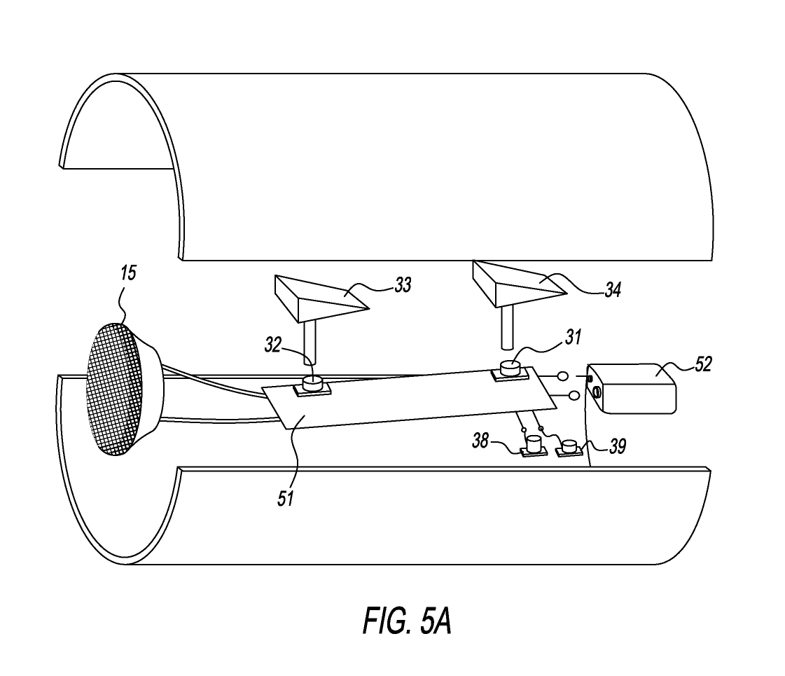

FIG. 5 is a diagram of the internal layout to inner casing 22. An ultrasonic transducer can be used as audio device 15 to produce the sound waves having a predetermined decibel level and a predetermined frequency. Circuit board 51 rests inside of inner casing 22 with switches 31, 32 that are activated by levers 33, 34, respectively. Circuit board 51 contains the circuits that control that production of signals to have ultrasonic transducer used as audio device 15 produce sound waves. Modernly, circuits can be miniaturized to produce the desired sound waves or an analog circuit can be used to produce the sound waves. Devices can be coupled to the circuit used to produce sound waves. Various mechanisms are envisioned as possible alternatives to activation devices. Switches, optical or other activation devices, can be configured to produce different volumes of sound. A battery supply can provide electrical power for circuits and the transducer.

In an embodiment, circuit board 51 is configured with a circuit to regulate the production of sound. The circuit board 51 can have an input or a set of inputs to receive signals from switches or other mechanisms used for activation. The signals are activated upon the occurrence of an event, for example, movement in a mechanical device, which can be used to trigger the activation mechanism. Once triggered by the signal, the activation device 10 will produce ultrasonic sounds. Switches 32, 33 are attached to the circuit board 51 and can be used to activate the ultrasonic sound. The switches 32, 33, or other activation device, can be configured to produce different volumes of sound. A battery supply 52 can be used to provide electrical power for the circuit board 51 and transducer 15. In an embodiment switch 38 provides for selectively changing frequency. In another embodiment switch 30 provides for a selection of small or large for the animal type with more sliding of inner and outing casings in 21, 22 for a larger animal.

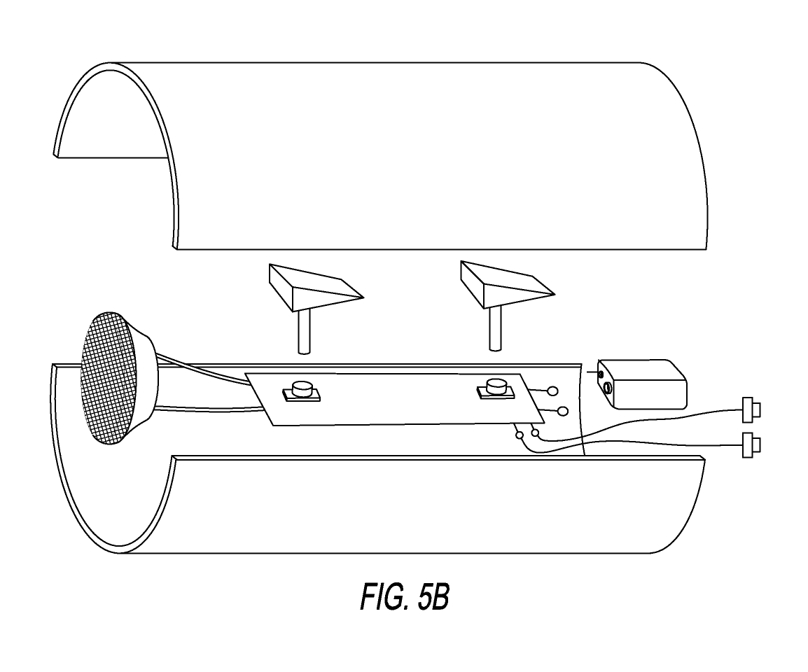

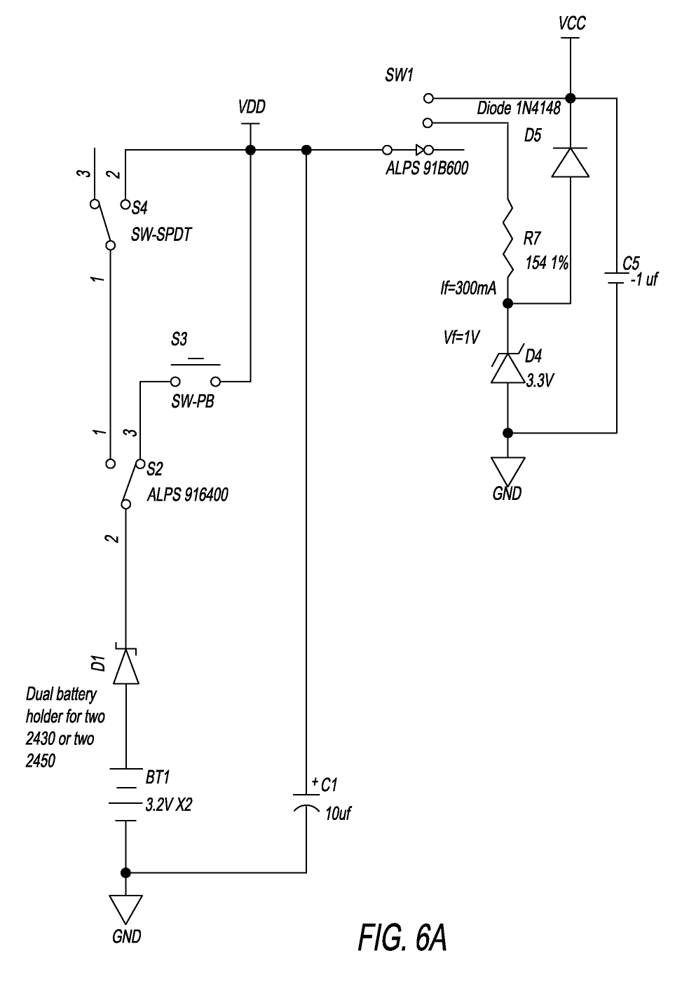

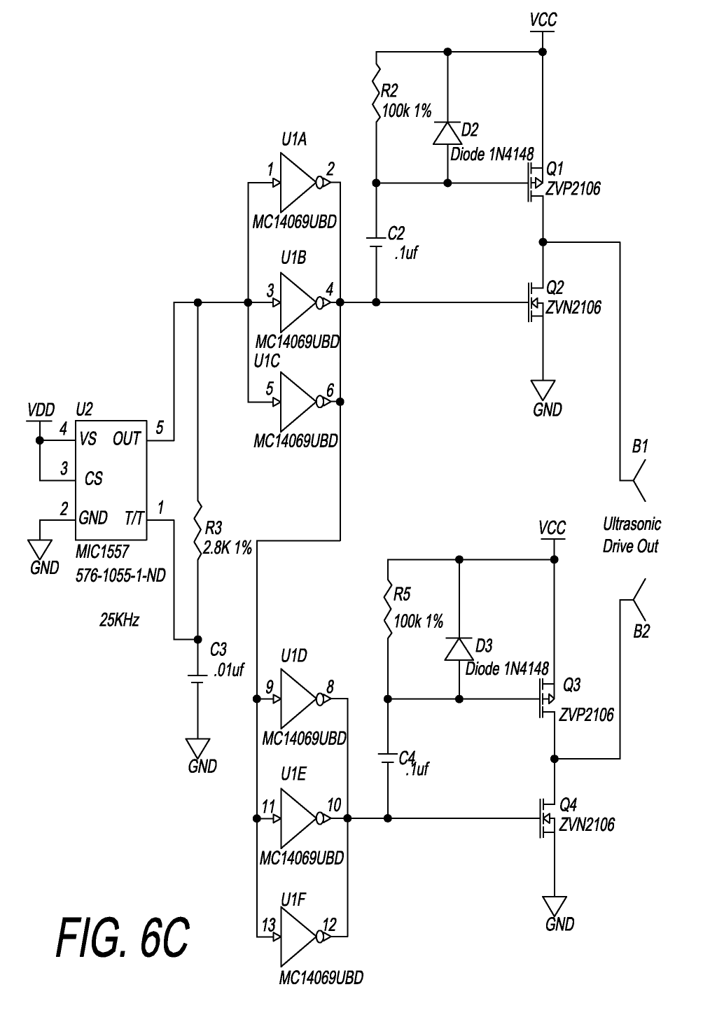

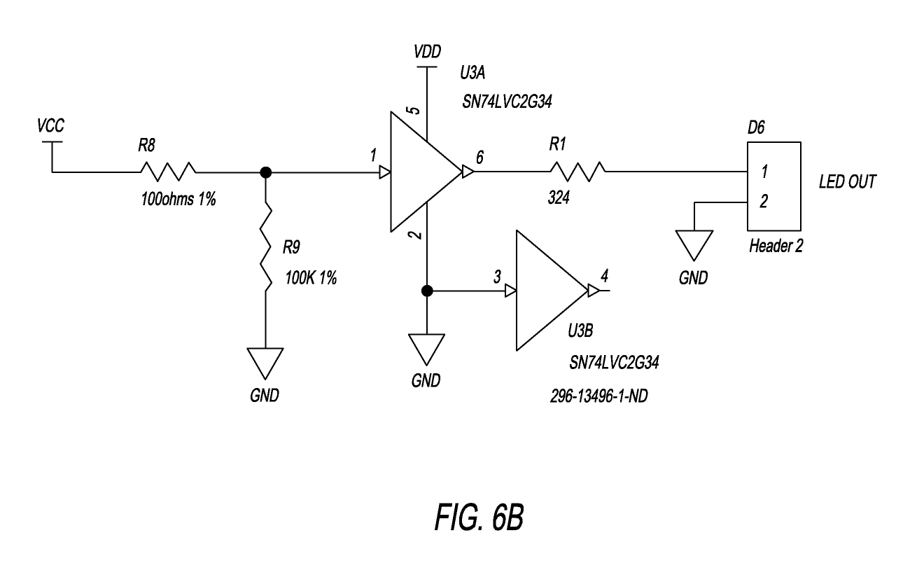

FIG. 6 is an example of a circuit that can be placed on circuit board 51. The circuit of FIG. 6 can be used to create the different frequencies. [Did you have another example of a circuit?] A sinusoidal wave is created from a 9 volt D.C. input. Included in FIG. 6 is a simple inverter oscillator which uses an R/C feedback circuit in which the resistor (R) and the capacitor (C) values are calculated to produce 25 Khz. Input 61 is the input from switch 31 and input 62 is the input from switch 32 in FIG. 5. In an embodiment, an indicator light 63 is provided to illuminate when the activation device 10 is producing ultra sonic sound waves to enable the human operator to understand the events as they occur. The circuit of FIG. 6 has ultrasonic transducer PZ1 that receives inputs from transformer T1. Transformer T1 receives inputs from two mirror transistor circuits. Transformer T1 has a 1:2 ratio. Therefore, application of a 9 volt p-p sine wave to the input of transformer T1 will result in twice that amount out of transformer T1, e.g. 18 volts. Labels 66, 67, and 68 are supply voltages the come from the switches 1, 2. R3 can control the frequency value has it is adjusted. L1 indicates inputs from switches 1, 2. R5 receives the input from switch 1, R10 receives the input from switch 2. The switches 1, 2 apply the power from battery 52 to R5, R10, respectively. R5 is 0 ohms for full power or maximum loudness. R10 can be selected to reduce volume output.

In an embodiment, a unit comprising the ultrasonic transducer 15, circuit board 51, and activation switches mechanism are incorporated two casing layers. Two casing layers are used to house the unit. The inner casing layer houses all electrical components. The ultrasonic transducer is attached to the inner casing in a way that it protrudes from the casing layer. The inner casing layer has multiple levers that can be pressed down into the casing layer. These levers operate the switches described earlier. The outer area of the inner casing layer must be in a cylindrical shape in order to accommodate the spring mechanism. A spring is placed around the cylindrical part of the casing and the outer casing layer is then attached. The spring can vary in strength and size to obtain a wide range of applications. At one end of the inner casing layer an attachment device, such as a clip, is attached.

The outer casing layer is slightly larger than the inner casing. The inner area of the outer casing layer can be cylindrically fashion in a particular embodiment. The outer casing will cover the inner casing entirely with the exception of one of the switches. The other switch(es) will be covered with a hood that protrudes from the outer casing layer. The hood will be elevated over the switch(es). At one end of the outer casing layer an attachment device, such as a clip, is attached. The end used must be the opposite side from the inner casing attachment device.

The device operates in multiple ways. One being to keep an animal from pulling on a leash. The device can be attached to the animal's collar, harness, or similar apparatus via the attachment device on the casing layer. The other attachment device on the other casing layer is attached to the leash. When the animal pulls forward the outer casing layer is extended outwards and the spring mechanism retracts. When the animal is not pulling and there is no pressure applied, the spring pressure retracts the outer casing layer back over the inner casing layer and the spring is back in its original position.

When the outer casing layer is extended it moves forward depressing the levers on the inner casing layer in an ordered fashion. The first lever depressed activates a switch which activates an ultrasonic sound. As the outer casing continues to extend outwards, the next switch(es) are depressed. The lever(s) produce(s) an ultrasonic noise that is higher than the volume(s) produced by the preceding lever(s).

The device can be used manually without attachment to the animal. A person can hold the device freely and operate the lever(s) on the inner casing layer that are not covered by the outer casing. This can be used for behavior modification in an animal.

Other embodiments may be used with clips, harnesses, collars as well as any other restraining device. The embodiments may be used with any suitable animal including dogs, cats, horses, and any other animal that can hear the designated frequency such as ranges in the 20 kHz to 30 kHz or any other suitable range. The described embodiments may also be used with a leash, rope, chain or any other suitable restraining element which is attached at one end to a stationary object, a person such as a walker of the animal or any other element which can substantially secure the embodiment and the attached animal so that the animal remains in proximity to the embodiment.

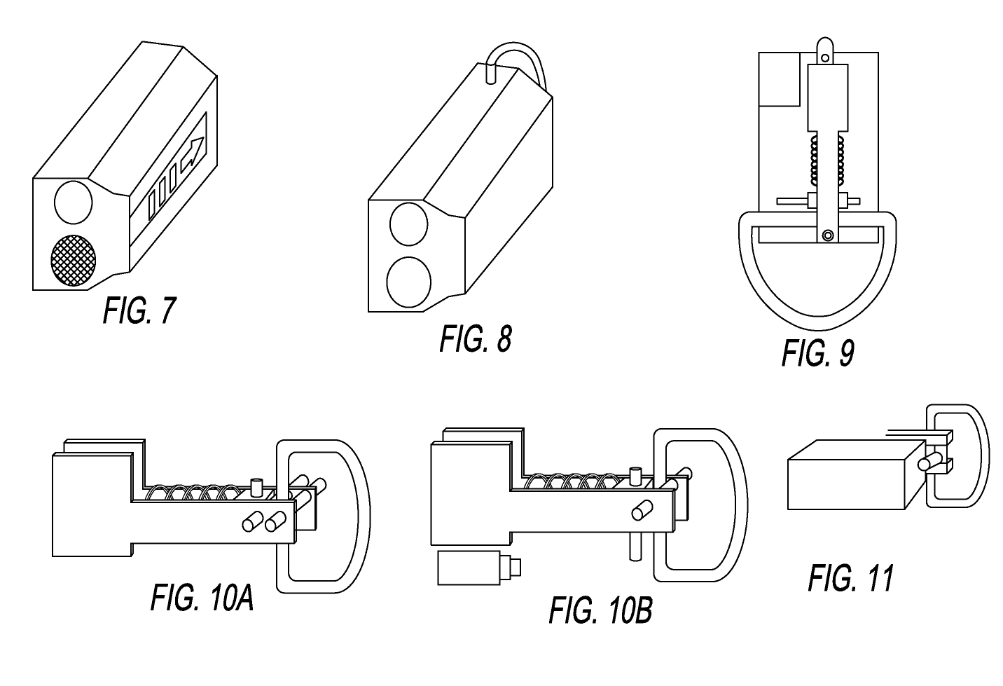

FIG. 7 is an illustration of another embodiment of the inventive subject matter showing the aperture in which a line may be used to hold an animal. In this embodiment, when the animal attached to the device pulls away from the device a spring is compressed by a rod that is compressed/extended out of the device by the pulling action. When the rod reaches a predetermined activation point on the PCB, an frequency wave or waves are activated and emitted and the noise/signal emitted by the device is heard by the animal. When the animal stops pulling, the spring tension pulls the device back into the device which signals the PCB to deactivate the frequency wave or waves so that the noise emitted from the device stops.

In several embodiments, a manual mode is provided to the animal does not need to pull the device in order for it to emit a noise. In these embodiments, a user can manually activate the production or cessation of the noise with or without action by the animal connected to the device. In several of the embodiments, the level of noise can be adjusted manually by the user or it may be adjusted automatically by the PCB, for instance in relation to the distance the animal is from the device. This information may be gathered from any suitable distance reading device known to those skilled in the art.

FIG. 8 is an illustration of the embodiment of FIG. 7 with a clip attachment positioned at the rear of the embodiment. The clip could then be attached to a lead line which is in turn attached to an animal that can pull forward, pull back or not move in relation to the embodiment.

FIG. 9 is an illustration of the embodiment of FIG. 7 shown from the top with a clip attachment positioned at the rear of the embodiment and the slideable mechanism with spring attached to the clip. The PCB assembly is shown under the slideable mechanism and spring.

FIGS. 10A and 10B are illustrations of several components an embodiment of FIG. 7 with a clip attachment positioned at the rear of the embodiment. FIG. 10A shows the spring in an extended position and FIG. 10B shows the spring in a compressed position.

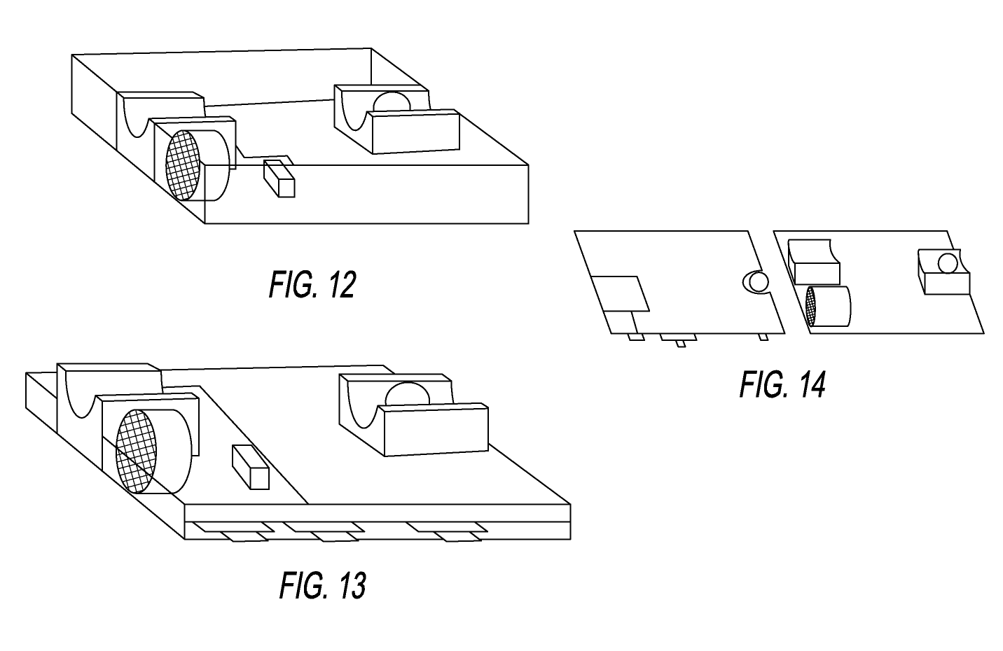

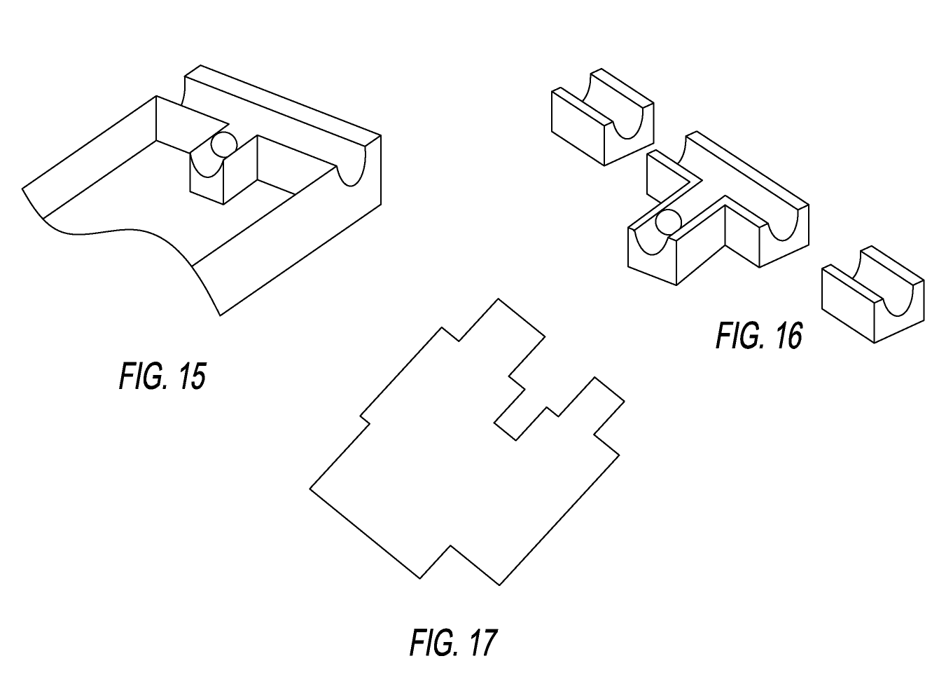

FIG. 11 is an illustration of the embodiment of FIG. 7 showing the use of the embodiment with an external 9 Volt battery supply and FIG. 12 shows a breakaway view of a PCB with side walls according to an embodiment of the subject matter. FIG. 13 shows a breakaway view of an embodiment with a PCB without side walls and FIG. 14 shows additional housing configurations used with embodiment of the subject matter.

Another embodiment includes a frequency changing switch which can also lower the frequency to the audible range for humans. Additional embodiments may emit both ultrasonic frequencies and frequencies audible by humans. In several of these embodiments, a user may select one or both of these functions so that the emitter emits one or more than one frequencies when the emitter is activated by the apparatus 10.

In other embodiments, an additional speaker may be used with the apparatus 10, for example a mini loud speaker or other audible frequency generator known to those skilled in the art. In several of these embodiments, the additional audible frequency generator may be used in conjunction with the ultrasound generator, for example to have more than one reinforcement sound provided to the animal for more effective training results. The one or more additional sounds which are audible to humans also provide a signal that lets the person know when the animal is pulling. This will not only increase the effectiveness of the animal training, but also aid in the understanding of the results of the training by the person using the apparatus or third parties observing the use of the apparatus 10. For example, a person training a dog can know when the dog is pulling via this alarm and can take the corrective action such as a tug back, a command to stop walking, or a verbal command to heal. This would reinforce the audible sounds received by the dog. In other embodiments, the apparatus 10 may use an additional audible frequency generator to emit before the ultrasound is emitted to aid in training the dog to stop pulling prior to the ultrasound going off, and to allow the trainer to take corrective measures before the ultrasound is emitted.

In several embodiments, a light such as an ultra-bright light LED or light emitting diode can be attached to the device to activate in the same manner as the audible loud speaker. This light can give the dog additional corrective stimuli to train the animal which would aid the sound generated to more effectively train the animal. The embodiments may also be used as a personal safety device for the animal, the trainer and/or third parties. For example, one or more loud speakers can be used to ward off attacks and draw attention to an emergency situation. Additionally, a light such as an ultra bright light LED may be used for night and low light conditions to aid in visibility.

In other embodiments, the apparatus 10 further includes a shut off safety timer. In these embodiments, the apparatus could be set to shut off at a certain point. For example, this element would shut the sounds off if a dog was left unattended and the sounds were to be continuously emitted, for instance in a situation such as when the dog was caught up on the device or wrapped in its leash which would make the apparatus emit sound continuously.

In many embodiments, a spring is used with the apparatus 10 but any suitable elastic material or other material with spring like properties may be used. Similarly, in many of the embodiments, a limit switch is used to actuate or trigger the emitted but other elements such as proximity/reed switch with a magnet may also be used in conjunction with or instead of the limit switch. Other embodiments may use a contract break instead of the closing a contact point. For example, two contacts that connect on the same pull mechanism may be used. In these embodiments, if the housing where to break, the unit would still work. In these embodiments, the two contacts may be positioned on the same plane with the wire leads wrapped around to ensure the device will continue to work should the housing break.

In several of the embodiments, a metal or polymer pull mechanism may be used to attach the leash to the collar. In these as well as other embodiments, the apparatus 10 may be used with any animal restraining device including but not limited to collars, harnesses, muzzles.

In many of the embodiments, the frequency emitted may be changed by the user or the apparatus may be made to send out different frequencies. For example, a user may use the limit switch so that the apparatus 10 emits more than one frequency and these frequencies may be used to train more than one animal simultaneously.

In several of the embodiments, the apparatus 10 uses a clip (such as a swivel clip positioned at the rear of the housing) and this clip may be used in order to allow the leash to be looped around the animal's neck and threaded through the clip. In these embodiments, a separate collar would not be needed as the leash (formed as a loop) would function as a collar.

In several of the embodiments, a LED indicator light may be used to indicate if there is a sufficient voltage to drive the piezo. For example a zener diode, additional diodes, and a resistor may be used. A light may also be used to indicate a low battery or a malfunction of the PCB board controller. For example, a led indicator can be used by splitting up the positive and negative pulses and running battery checks on both currents. If the currents are not identical, the light could emit indicating a potential malfunction with the board.

In several of the embodiments, the apparatus 10 may 3 coin lithium batteries as a power source. In other embodiments, rechargeable batteries may be used with the apparatus 10 and those batteries could be plugged into an external power source and periodically recharged.

Although the foregoing embodiments of the inventive subject matter have been described in some detail by way of illustration and example for purposes of clarity and understanding, it will be apparent to those of ordinary skill in the art in light of the teaching of this invention that certain changes and modifications may be made thereto without departing from the spirit or scope of the inventive subject matter including the appended claims.

1. A device for training animals comprising:
a housing with a connector for a leash;
a noise emitter capable of producing one or more noises with one or more ranges of frequencies;
a circuit that signals the audio device to provide or stop the one or more noises; and
a switch to activate said circuit;
wherein said circuit is activated when said leash is pulled with a predetermined amount of force activating said noise emitter which produces said one or more noises, and
wherein the circuit is deactivated when the leash is released so that the noise emitter stops emitting noise.

2. The device for training animals of claim 1 wherein said one or more noises are sounds with different amplitudes.

3. The device for training animals of claim 1 wherein said one or more noises are sounds with different frequencies.

4. The device for training animals of claim 1 further comprising a frequency changing switch for allowing a user to change the frequency of the one or more noises being emitted.

5. The device for training animals of claim 1 further comprising an audible frequency generator.

6. The device for training animals of claim 1 further comprising a light emitting source.

7. The device for training animals of claim 1 further comprising a shut off safety timer.

8. The device for training animals of claim 1 wherein said switch is a limit switch.

9. The device for training animals of claim 1 wherein said switch is a proximity/reed switch with a magnet.

10. The device for training animals of claim 1 wherein said switch is a proximity/reed switch with a magnet.

11. The device for training animals of claim 1 wherein said one or more noises are used to train more than one animal simultaneously.

12. The device for training animals of claim 1 further comprising a low battery indicator.

13. The device for training animals of claim 1 further comprising a circuit malfunction indicator.

14. A method of training animals comprising the steps of walking an animal on a leash and producing one or more noises when the animal pulls the leash with a specified amount of force wherein said sound is produced with a device comprising:
a housing with a connector for a leash;
a noise emitter capable of producing one or more noises with one or more ranges of frequencies;
a circuit that signals the audio device to provide or stop the one or more noises; and
a switch to activate said circuit;
wherein said circuit is activated when said leash is pulled with a predetermined amount of force activating said noise emitter which then produces said one or more noises, and
wherein the circuit is deactivated when the leash is released so that the noise emitter stops emitting noise.

15. The method of training animals of claim 14 wherein said one or more noises are sounds with different amplitudes.

16. The method of training animals of claim 14 wherein said one or more noises are sounds with different frequencies.

17. The method of training animals of claim 14 wherein said device further comprises a frequency changing switch for allowing a user to change the frequency of the one or more noises being emitted.

18. The method of training animals of claim 14 wherein said device further comprises an audible frequency generator.

19. The method of training animals of claim 14 wherein said device further comprises a light emitting source.

20. The method of training animals of claim 14 wherein said device further comprises a shut off safety timer.
